(19) United States
(12) Patent Application Publication
(10) Pub. No.: US 2011/0271716 A1
(43) Pub. Date: Nov. 10, 2011

(54) METHOD FOR PRODUCING THERMALLY TEMPERED GLASSES

(76) Inventors: Heiko Hessenkemper, Grossschirma (DE); Michael Hennig, Freiberg (DE)

(21) Appl. No.: 13/061,826

(22) PCT Filed: Sep. 8, 2009
(86) PCT No.: PCT/EP2009/061611

§ 371 Date: May 26, 2011

(30) Foreign Application Priority Data
Sep. 8, 2008 (DE) 10 2008 046 044.3
Dec. 17, 2008 (DE) 10 2008 062 362.8

(51) Int. Cl. C03B 27/004; C03B 27/02; C03B 33/02

(52) U.S. Cl. 65/26; 65/112; 65/116; 65/29.19

(57) ABSTRACT

A method for producing thermally tempered glass. This type of surface treatment is applied in particular where mechanical properties, in particular strengths, are required, for example in the automotive industry, in architecture and in the utilisation of solar energy. The method produces thermally tempered glass with thicknesses less than 2.8 mm. The method can be advantageously performed such that thermally tempered glass can be produced with less energy input by utilising controlled quenching.

### BACKGROUND OF THE INVENTION

The invention relates to a method for producing thermally tempered glass.

Surface-treated glass plays an ever-greater economic role, with thermally tempered glass accounting for a major proportion of that product category. This type of surface treatment is applied in particular where mechanical properties, in particular strengths, are required, for example in the automotive industry, in architecture and in the utilisation of solar energy. “Single-pane safety glass” (SPSG) is defined in respect of its properties, test methods, etc., in a special standard. This standard is specified in DIN EN 12150-1: Thermally pre-stressed soda-lime single-pane safety glass, November 2000. It is noteworthy that this standard exists only for glass with a minimum thickness of 3 mm. A market analysis shows that SPSG glass is obtainable on the market only in thicknesses of 2.8 mm or more. Thin, thermally tempered glass with thicknesses significantly less than 2.8 mm, with the same or even significantly improved mechanical properties as SPSG glass would result in strategic optimisation in the most diverse fields of application, from weight reductions, cost reductions and improved transmission properties to logistical advantages. A large number of new application fields, markets and cost reductions are conceivable when such glass is used as a constituent of products such as laminated safety glass (VSG), armoured glass or vacuum insulating glass.

The question is therefore raised as to why such thin, thermally tempered glass with high inherent compressive stress does not exist. To answer that question, it is necessary to consider the production process. SPSG glass is firstly heated, in the case of normal soda-lime silicate glass composition, such as float glass, to approximately 680° C. This is followed by quenching with air quenching, which firstly cools the surface, in the process of which a temperature gradient is produced, initially at the surface, which in turn causes surface tensile stress which transforms into surface compressive stress when the entire glass body cools down to room temperature. These processes have been described in detail and quantitatively in W. Kiefer: “Thermisches Vorspannen von Gläsern niedriger Wärmeausdehnung”, Glastechnische Berichte 57 (1984) No. 9, pp. 221-228. For thinner glass that is thermally tempered, greater temperature gradients are necessary to achieve the same compressive stresses, and are only possible with more intensive cooling. Although this is basically possible, for example by liquid cooling, it results in the temporary tensile stresses produced on the surface during cooling leading to destruction of the glass. Liquid cooling is used in the case of borosilicate glass, for example, but this is only possible because the latter have a much lower thermal coefficient of expansion amounting to only about 40% of those of a standard, commercially available float glass. However, this means that the tensile stresses and the permanent inherent compressive stresses at room temperature also have a correspondingly lower value, for the same cooling measures. If a soda-lime silicate glass were to be cooled more rapidly, more and more glass would be destroyed during the cooling process, according to the strength distribution in a glass batch. As a basic principle, this means that 2 mm glass is conceivable, but only a fraction of a glass batch would not be destroyed by this treatment step, which explains the industrial non-existence of such glass despite the strong market interest in such glass.

D1 discloses a method for producing a thermally tempered glass having a thicking of 2.2 mm, in which the glass is heated in a first step in a central part and with exclusion of a peripheral part, and is subjected in a second step to quenching. Heat treatment limited to the peripheral part is performed using laser cutting. Quenching limited to the peripheral part is performed with CO₂ or liquid nitrogen vapour.

The object of the invention is to develop a method for producing thermally tempered glass with thicknesses less than 2.8 mm.

### SUMMARY OF THE INVENTION

The basic idea of the new method is to subject the glass which is to be thermally tempered to methods, during the heating process, that increase the strength of the glass.

### DETAILED DESCRIPTION

In developments of the invention, suitable such methods are the laser cutting methods found on the market, which increase the bending strength by more than 100% and which reduce the causes of breakage emanating from the edges. In addition or alternatively, flame burnishing or treatment with AICl₃ may be performed, as disclosed in WO 2004/096724 A1, the actual disclosure in which is hereby incorporated by reference in the actual disclosure of the present application. The increases in strength thus achieved now permit higher tensile stresses during the cooling phase, and hence higher temperature gradients and ultimately either higher compressive stresses for the same thickness, or the same compressive stresses for lower thicknesses, or a combination of both improvements in properties. This can be achieved by quenching with media having a heat transfer coefficient in use that is greater than 400 W/m²K. Various cooling methods are described in W. Kiefer: Thermisches Vorspannen von Gläsern niedriger Wärmeausdehnung; Glastechnische Berichte 57 (1984) No. 9, pp. 221-228, the disclosure in W. Kiefer: Thermisches Vorspannen von Gläsern niedriger Wärmeausdehnung; Glastechnische Berichte 57 (1984) No. 9, pp. 221-228 being hereby incorporated by reference in the disclosure of the present invention.

This method, which is based on upstream measures for increasing the glass strength, is possible for any composition of glass, and the cooling rates can be increased respectively on the basis of the original expansion coefficients to the extent that the temporary increase in strength is effective during the cooling operation.

The possibility of now using liquid phases for thermally tempering soda-lime silicate glass potentially provides additional advantages besides substantial cost savings. Surface treatments are often desired, for example in respect of visual properties or chemical resistance. As is known from the prior art, this can be achieved on a permanent basis by enrichment with SiO₂ on the surface, the reduced refractive index causing a reduction in reflectance losses and an increase in transmission, while simultaneously increasing the chemical resistance. This can be achieved with two basic measures:

1.) Decreasing the amount of other elements, e.g. dealkalisation. Example: By cooling with a 3% (by weight) ammonium sulphate solution, the hydrolytic stability can be doubled, while simultaneously improving the transmission curves by 0.5% at the expense of reflection.
2.) Adding SiO₂ suspension with the aqueous solution during cooling, wherein solutions known from sol-gel technology can be used to achieve additional optimisation in respect of mechanical, chemical and visual properties.

This reactive thin film deposition is combined with the method of thermal tempering, made possible by using liquid phases to cool glass, including glass with a high thermal expansion coefficient, which in turn is made possible only by applying measures that increase the strength of the glass.

One particularly preferred variant is based on further development of the method for producing thermally tempered glass according to the concept of the invention, or a development thereof as described in the foregoing.

The concept described above specifically addresses the problem of developing a method for producing thermally tempered glass with thicknesses less than 2.8 mm. The basic idea is to subject the glass which to be thermally tempered to methods, during the heating process, that increase the strength of the glass. Suitable such methods are the laser cutting methods found on the market, which increase the bending strength by more than 100% and which reduce the causes of breakage emanating from the edges. In addition or alternatively, flame burnishing or treatment with AICl₃ may be performed. The increases in strength thus achieved now permit higher tensile stresses during the cooling phase, and hence higher temperature gradients and ultimately either higher compressive stresses for the same thickness, or the same compressive stresses for lower thicknesses, or a combination of both improvements in properties. This is achieved by quenching with media having a heat transfer coefficient in use that is greater than 400 W/m²K.

It has been recognised, by developing the invention, that quenching with liquid media is difficult to handle as far as controlled cooling is concerned, which means that a safety range must be complied with in order to prevent breakage of glass. Due to the heating and cooling processes, the production of thermally tempered glass consumes substantial amounts of energy.

It is an object of the particularly preferred development to develop the method according to the concept of the invention in such a way that thermally tempered glass can be produced with less energy input, using controlled quenching.

This object is achieved by inserting the glass in a cold state into a plate cooler with heating capability, heating it to a temperature greater than the transformation temperature of the glass, wherein the material surfaces in contact with the glass may have a maximum temperature at which the glass would have a viscosity greater than 108.5 Pas, then subjecting the glass to controlled cooling and removing the glass in a cold state from the plate cooler. The plate cooler used may consist of different metals, such as Cu, Al, steel and others, including alloys thereof. This plate cooler should be capable of heating and cooling, in order to be able to adjust the respective temperature gradients in the glass that are required to produce different kinds of glass (in respect of chemical composition, thickness). In addition to an appropriate heat penetration coefficient, the material should also withstand the continual changes in temperature while retaining its shape, either as a monolithic material or as a combination of materials, for example as a brace around the basic material. Controlled cooling is achieved by measuring the difference in temperature between the glass surface and the middle of the glass during cooling, and using this variable to control the cooling process. The surface temperature can be set by means of thermoelements in the surface of the plate cooler or by means of pyrometer measurement at a range of 5 μm. A maximum temperature during cooling can be identified, and/or a temperature profile across a cross-section of the glass can be detected using a focused high-resolution pyrometer which is moved laterally back and forth across the thickness of the glass. The glass plate represents a black body in respect of its thickness, which means that, assuming a stable temperature distribution across the thickness, it is possible to measure the inner temperature in a stable manner across the entire surface during the entire cooling process. Results obtained from pivoting pyrometer measurements on an 8 mm pane of float glass are shown in the drawings (FIG. 11). The measured inner temperature can be used to control the cooling process.

The temperature gradients to be introduced are based on the thickness of the glass and the temperature-dependent, glass-specific properties, such as expansion coefficient, effective thermal conductivity and elastic properties. In order to control the heat transfer, and with the aim of uniform contact, the use of special “lubricants” is recommended, for example aluminium soap, dealkalising substances, (examples: sulphates (ammonium sulphate) or chlorides (aluminium chloride)). Direct and indirect methods are used for cooling and heating (resistance heating, inductance heating, flame heating. Cooling: water, salts (utilising the aggregation conversion heat), air cooling and combination of these various methods.

The plate cooler eliminates the waviness problem for thin panes of glass by forcing them into a parallel shape. With flexible plates, it is possible to shape the glass before thermal tempering by cooling begins. Nonplanar geometries with thermal tempering are made possible in this way.

Variant (of the invention) shall now be described with reference to the drawings. The variants are not necessarily meant to be shown according to scale; rather, the drawings are provided in schematic and/or slightly distorted form wherever this is aids explanation. Reference is made to the relevant prior art for further details about technical principles that are not immediately evident from the drawings. Account should be taken of the fact that many modifications and changes to the shape and details of a variant, without deviating from the general idea of the invention. The features of the invention disclosed in the description, in the drawings and in the claims may be essential, both separately and in any combination, for development of the invention. In addition, all combinations of at least two of the features disclosed in the description, the drawings and/or the claims fall within the scope of the invention. The general idea of the invention is not limited to the exact shape or detail of the preferred variants shown and described in the following, nor is it limited to one subject-matter that would be limited in comparison to the subject-matter in the claims. When measurement ranges are specified, values within the specified limits are also disclosed as threshold values and may be applied and claimed at will. For the sake of simplicity, the same reference numerals are used in the following for identical or similar parts, or for parts which have identical or similar functions.

### BRIEF DESCRIPTION OF THE DRAWINGS

Further advantages, features and details of the invention derive from the following description of the preferred variants and with reference to the drawings, in which

FIG. 1 shows a picture of damage to a 4 mm thick glass pane treated in a preferred variant of the method in Example 1;

FIG. 2 shows a picture of damage to a 2 mm thick glass pane treated in a preferred variant of the method in Example 2;

FIG. 3 shows a picture of damage to a 2 mm thick glass pane treated in a preferred variant of the method in Example 3;

FIG. 4 shows a schematic sketch, with description, of a system comprising a plate heater and a plate cooler for one variant of the particularly preferred development of the method;

FIG. 5 shows a schematic sketch, with description, of a tandem system for one variant of the particularly preferred development of the method;

FIG. 6 shows fracture patterns of panes, with description, which have been treated according to one variant of the particularly preferred development of the method, with direct-contact cooling;

FIG. 7 shows a fracture pattern of a pane, with description, comparing 4 mm (left) and 2 mm (right) panes after thermal tempering and/or direct-contact cooling according to one variant of the particularly preferred development of the method;

FIG. 8 shows fracture patterns of panes, with description, which have been treated according to one variant of the particularly preferred development of the method, with direct-contact cooling;

FIG. 9 a tensile test image of a 2 mm pane, with description, which has been treated according to one variant of the particularly preferred development of the method, with direct-contact cooling;

FIG. 10 shows a tensile test image of a conventionally treated pane of automotive glass;

FIG. 11 Results, with description, of pivoting pyrometer measurements at an 8 mm pane of float glass which has been treated according to one variant of a particularly preferred development of the method.

### EXAMPLES

The method according to the idea of the invention shall now be explained with reference to the following examples.

### Example 1

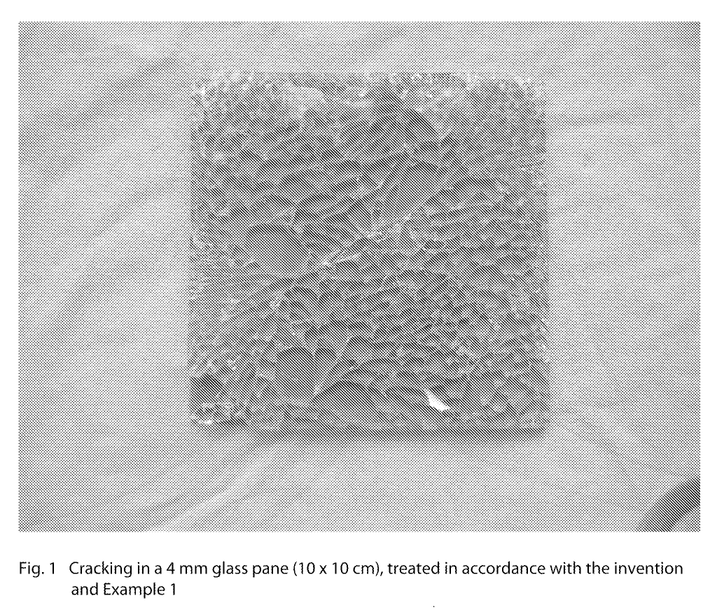

A float glass pane based on commercial soda-lime silicate glass, having a thickness of 4 mm and cut to size by laser cutting, is heated to an integral temperature of 680° C. and cooled, after removal from the furnace, by spray cooling on both sides for a maximum of 30 seconds using 11/minute on a surface measuring 2 by 100 cm². The picture of cracking shown in FIG. 1 is obtained using a standard, commercially available impact punch tool. A similar pane of float glass not cut to size by laser cutting broke when spray cooling was applied.

### Example 2

A float glass pane based on commercial soda-lime silicate glass, having a thickness of 2 mm and cut to size by laser cutting, is heated to an integral temperature of 680° C. and cooled, after removal from the furnace, by spray cooling on both sides for a maximum of 30 seconds using 2 I/minute on a surface measuring 2 by 100 cm².

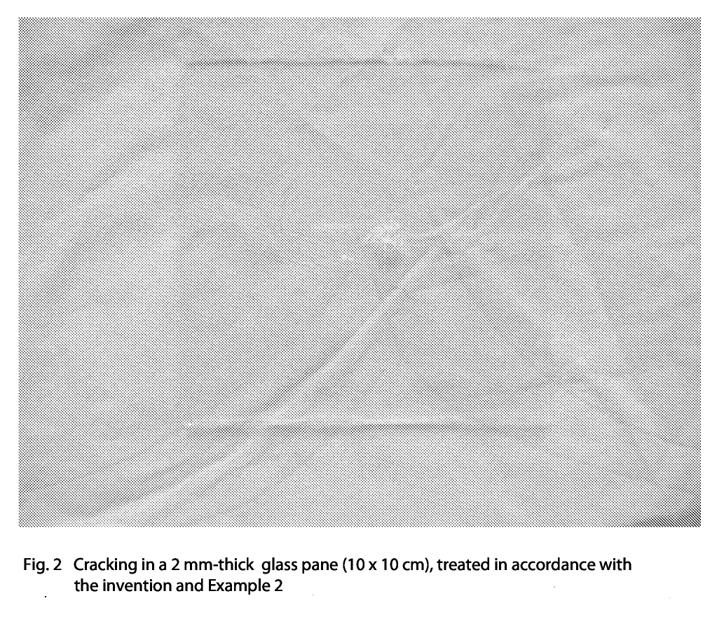

The defects shown in FIG. 2 is obtained using a standard, commercially available impact punch tool. A similar pane of float glass not cut to size by laser cutting broke when spray cooling was applied.

### Example 3

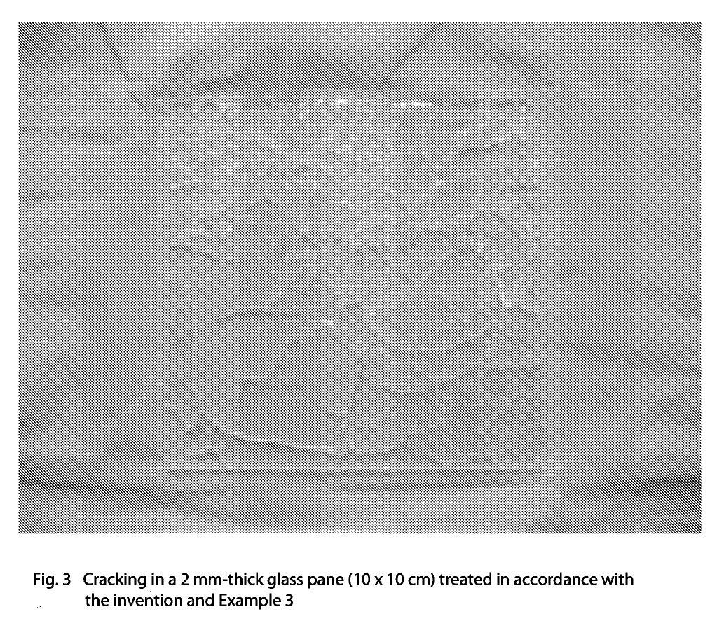

A pane of float glass on a commercial soda-lime silicate glass basis with a thickness of 2 mm, cut to size by laser cutting, is heated to an integral temperature of 680° C. Treatment with aluminium chloride is carried out simultaneously with heating. After the glass has been removed from the furnace, it is cooled by spray cooling both sides for a maximum of 30 seconds using 4 l/minute on a surface measuring 2 by 100 cm². The fracture image shown in FIG. 3 is obtained using a standard, commercially available impact punch tool. A similar pane of float glass not cut to size by laser cutting broke when spray cooling was applied.

The following examples describe the method according to the particularly preferred development of the invention.

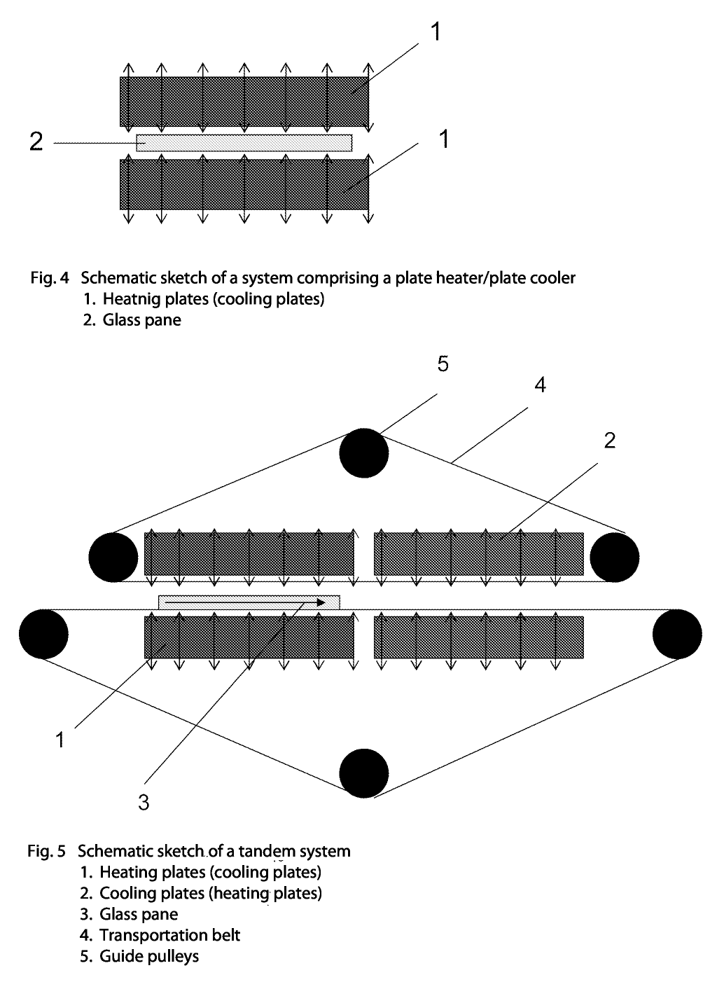

FIG. 4 shows the principle of a system for thermally tempering according to the particularly preferred method. A particularly advantageous variant of the method is one in which two plate coolers are combined as a tandem system by alternately cooling and heating using a thermal transfer and storage medium. If system A is cooled with the latter medium, then system B is heated with it, and vice versa. The principle is shown in FIG. 5.

### Example 4

A pane of float glass on a commercial soda-lime silicate glass basis, having a thickness of 4 mm and cut by laser cutting to 100 mm×100 mm, was heated on a refractory support in a muffle furnace at a furnace temperature of 750° C. for four minutes. Measurement using a thermoelement between the support and the pane showed clearly that the temperature of the pane had reached at least 700° C. After the pane had been heated, it was pulled out of the furnace with the support and inserted between the cooling plates. This operation must be carried out rapidly in order to lose as little heat as possible. In the tests, the time taken to move the pane from the position in the furnace to the position between the cooling plates was less than four seconds. The dwell time between the cooling plates was two minutes in the case of the 2 mm thick panes.

In the laboratory tests, cooling plates made of two different materials, graphite and steel, were used. The steel plates were heated to a temperature of approximately 90° C. to ensure that the transfer of heat from the glass into the cooling plates did not become too extreme. The graphite plates were not separately heated, but warmed up very well by themselves in the course of a few test runs. To ensure that the surface quality of the panes was as good as possible and to ensure good contact between the glass and the plates, the cooling plates (graphite and steel) were ground or polished on one side. Some panes were destroyed with a spring-loaded punch in order to evaluate the fracture pattern. A surface defect is placed exactly in the middle of the pane.

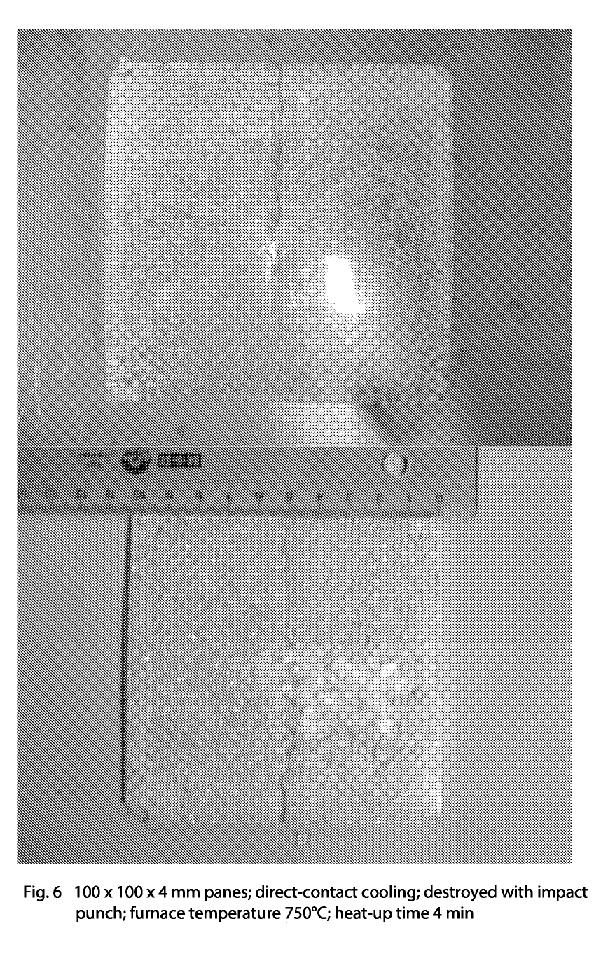

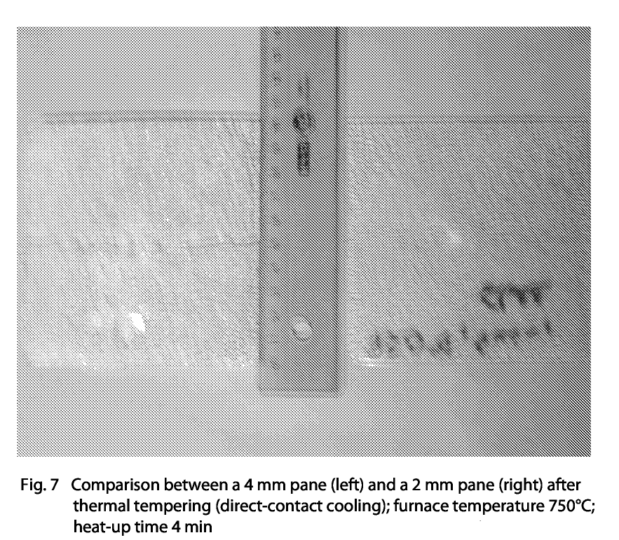

The fracture patterns obtained (FIG. 6 and FIG. 7) were significantly better than required by the DIN standard for single-pane safety glass (DIN 12150; thermally pre-stressed soda-lime single-pane safety glass (SPSG)).

### Example 5

A pane of float glass on a commercial soda-lime silicate glass basis, with a thickness of 2 mm, was treated analogously to Example 4. The steel cooling plates were heated to a temperature of 80° C. Some panes were destroyed using a spring-loaded punch in order to evaluate the fracture pattern. A surface defect is placed exactly in the middle of the pane.

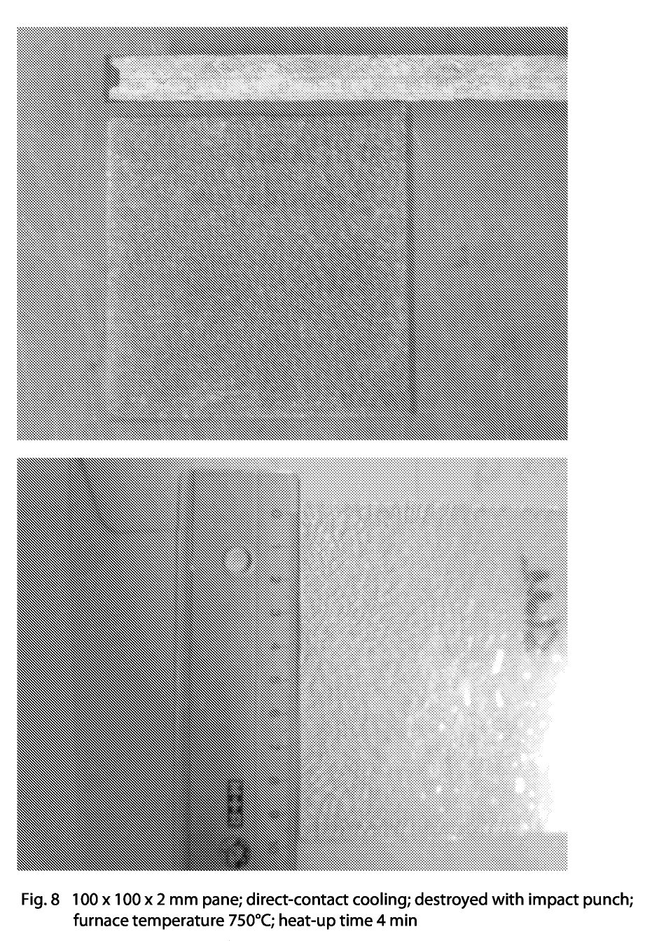

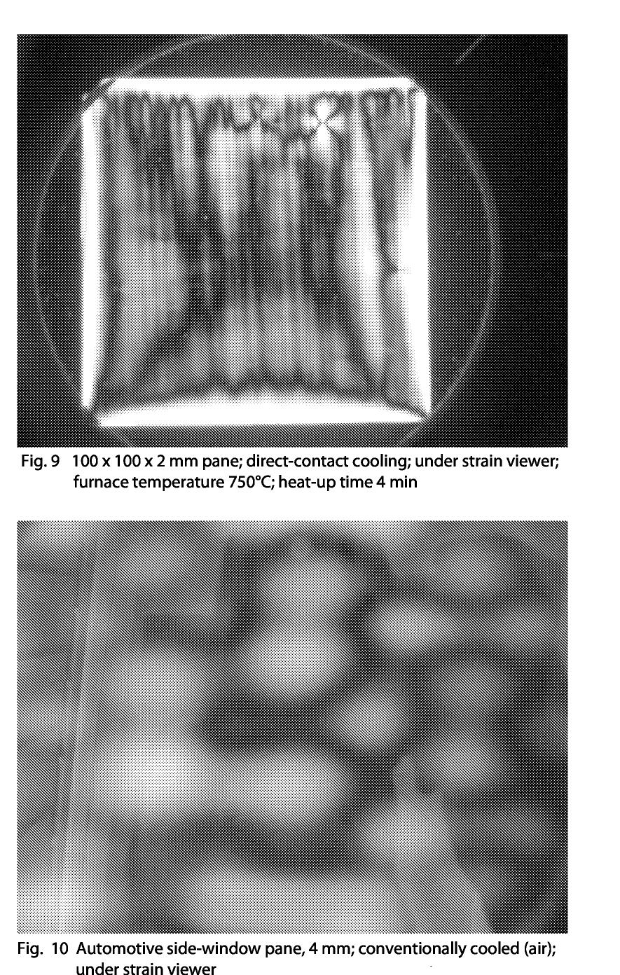

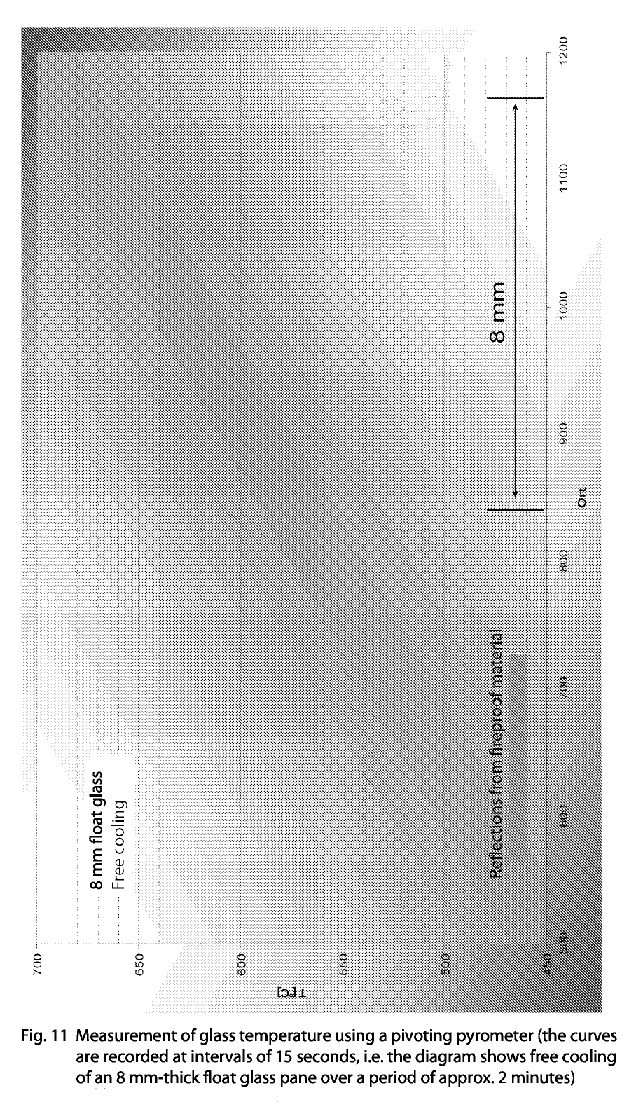

The fracture patterns obtained (FIG. 7 and FIG. 8) were significantly better than required by the DIN standard for single-pane safety glass (DIN 12150; thermally pre-stressed soda-lime single-pane safety glass (SPSG)). FIG. 9 shows a tensile test image of a 2 mm pane. As a comparison, FIG. 10 shows the tensile test image of a conventionally treated automotive glass pane.

### Example 6

To subject the panes to chemical treatment, the cooling plates were rubbed with an aluminium soap, and ammonium sulphate solution was added to the muffle furnace. These options were tested separately and also in combination. In order to evaluate the result of treatment, the hydrolytic strength the glass was determined in each case. The test conditions were as follows: 48 h at 90° C. in the drying cabinet. A high level of conductivity means poor chemical resistance. The following results were obtained:

| Treatment | Conductivity in μS/cm |
|---|---|
| None | 12.7 |
| None | 17.2 |
| None | 14.0 |
| Aluminium soap | 6.1 |
| Aluminium soap | 7.5 |
| Aluminium soap | 6.6 |
| (NH₄)₂S0₄ | 9.7 |
| (NH₄)₂S0₄ | 8.5 |
| Aluminium soap + (NH₄)₂S0₄ | 6.2 |
| Aluminium soap + (NH₄)₂S0₄ | 6.3 |
| Aluminium soap + (NH₄)₂S0₄ | 4.1 |
| Aluminium soap + (NH₄)₂S0₄ | 5.1 |

It can be seen that the conductivity decreases significantly as a result of the treatment.

1-17. (canceled)

18. A method for producing a thermally tempered glass, wherein the glass is heated as a pane with a thickness less than 2.8 mm in a first step and quenched in a second step, wherein measures that increase the strength of the glass are implemented before or during the first step, and the quenching in the second step is performed using media which in use have a heat transfer coefficient greater than 400 W/m²K, wherein before or during the first step of the method the glass is subjected to a laser cutting process and/or flame burnishing and/or treatment with AICl₃ and
(a) in the second step the quenching is performed by spray cooling using liquid phases and/or
(b) in the second step the glass is subjected to controlled cooling under direct-contact cooling in a plate cooler and removed in a cold state from the plate cooler.

19. The method of claim 18, wherein the glass is provided as float glass.

20. The method of claim 18, wherein the glass is completely treated.

21. The method of claim 20, wherein the strength is integrally increased for the glass.

22. The method of claim 20, wherein the quenching for the glass is performed two-dimensionally on a surface of the glass.

23. The method of claim 18, wherein the glass is formed on a soda-lime silicate basis.

24. The method of claim 18, wherein the pane has a thickness less than or equal to 2 mm.

25. The method of claim 18, wherein the quenching in the second step is performed using an ammonium sulphate solution.

26. The method of claim 18, wherein the quenching in the second step is performed using sulphurous acid.

27. The method of claim 18, wherein the quenching in the second step is performed using an aqueous SiO₂ suspension.

28. The method of claim 18, wherein the plate cooler has cooling plates made of one of graphite or metal selected from the group consisting of copper, aluminium, steel and alloys thereof.

29. The method of claim 18, wherein the glass is inserted in a cold state into a plate cooler with heating capability, heated to a temperature greater than the transformation temperature of the glass, wherein the material surfaces in contact with the glass may have a maximum temperature at which the glass would have a viscosity greater than 108.5 Pas.

30. The method of claim 29, wherein during cooling the difference in temperature between the glass surface and the middle of the glass is measured, and this variable is used to control the cooling process, said cooling process being dependent on the glass thickness and the type of glass.

31. The method of claim 30, wherein a surface temperature of the glass is detected using a thermoelement in a surface of the plate cooler, or using a pyrometer, in particular at a range of 5 μm, and/or in that a temperature profile across a cross-section of the glass is detected using a focused high-resolution pyrometer which is moved laterally back and forth across the thickness of the glass.

32. The method of claim 31, wherein a lubricant is deployed in the plate cooler.

33. The method of claim 32, wherein aluminium soap and dealkalising substances such as ammonium sulphate or aluminium chloride are used as lubricant.

34. The method of claim 18, wherein two plate coolers are combined as a tandem system in which cooling and heating are alternately performed using a thermal transfer medium and storage.
